(19) United States
(12) Patent Application Publication
(10) Pub. No.: US 2026/0175604 A1
(43) Pub. Date: Jun. 25, 2026

(54) LIQUID EJECTION APPARATUS

(71) Applicant: SEIKO EPSON CORPORATION, TOKYO (JP)

(72) Inventor: Shoma KUDO, SHIOJIRI-SHI (JP)

(21) Appl. No.: 19/430,777

(22) Filed: Dec. 23, 2025

(30) Foreign Application Priority Data
Dec. 23, 2024 (JP) 2024-226099

(51) Int. Cl. B41J 29/02; B41J 2/17; B41J 29/13; H04N 1/00

(52) U.S. Cl. CPC B41J 29/02; B41J 2/1721; B41J 29/13; H04N 1/00535; H04N 1/00543; H04N 1/00551

(57) ABSTRACT

A liquid ejection apparatus includes a liquid ejection unit configured to eject a liquid, a mounting portion on which a liquid container configured to store the liquid is mounted, a first rotary section configured to rotate about a first axis between a restriction position where movement of the liquid container mounted on the mounting portion is restricted and a permission position where the movement of the liquid container mounted on the mounting portion is permitted, a second rotary section configured to rotate about a second axis at a position where the second rotary section passes through a first position where the mounting portion is covered and a second position where the mounting portion is exposed, and a guide portion configured to rotate the first rotary section by coming into contact with the first rotary section. The guide portion rotates the first rotary section from the permission position toward the restriction position due to a rotational operation of the second rotary section from the second position to the first position.

The present application is based on, and claims priority from JP Application Serial Number 2024-226099, filed Dec. 23, 2024, the disclosure of which is hereby incorporated by reference herein in its entirety.

### BACKGROUND

### 1. Technical Field

The present disclosure relates to a liquid ejection apparatus.

### 2. Related Art

For example, as in JP-A-2020-146920, a liquid ejection apparatus including a housing cover capable of opening and closing an opening portion of a housing and a container cover that covers a part of a waste liquid box is disclosed. In such a liquid ejection apparatus, the waste liquid box, which is an example of a liquid container, can be attached and detached by accessing the waste liquid box through the opening portion. The container cover, which is an example of a first rotary section, is rotatable between a restriction position where the movement of the waste liquid box is restricted and a permission position where the movement of the waste liquid box is permitted. The housing cover as an example of a second rotary section is rotatable between a first position where an opening is closed and a second position where the opening is opened.

JP-A-2020-146920 is an example of the related art.

However, in such a liquid ejection apparatus, when the second rotary section is rotationally operated from the second position to the first position when the first rotary section is disposed at the permission position, there is a concern that the second rotary section pinches the first rotary section. Therefore, it is desired to improve the convenience of a user.

### SUMMARY

A liquid ejection apparatus that solves the problem described above includes a liquid ejection unit configured to eject a liquid, a mounting portion on which a liquid container configured to store the liquid is mounted, a first rotary section configured to rotate about a first axis between a restriction position where movement of the liquid container mounted on the mounting portion is restricted and a permission position where the movement of the liquid container mounted on the mounting portion is permitted, a second rotary section configured to rotate about a second axis at a position where the second rotary section passes through a first position where the mounting portion is covered and a second position where the mounting portion is exposed, and a guide portion configured to rotate the first rotary section by coming into contact with the first rotary section, wherein the guide portion rotates the first rotary section from the permission position toward the restriction position due to a rotational operation of the second rotary section from the second position to the first position.

### BRIEF DESCRIPTION OF THE DRAWINGS

FIG. 1 is a perspective view showing a liquid ejection apparatus according to a first embodiment.

FIG. 2 is a schematic diagram showing the liquid ejection apparatus according to the first embodiment.

FIG. 3 is a schematic diagram showing the liquid ejection apparatus according to the first embodiment.

FIG. 4 is a schematic diagram showing the liquid ejection apparatus according to the first embodiment.

FIG. 5 is a schematic diagram showing a liquid ejection apparatus according to a second embodiment.

FIG. 6 is a schematic diagram showing the liquid ejection apparatus according to the second embodiment.

FIG. 7 is a schematic diagram showing the liquid ejection apparatus according to the second embodiment.

FIG. 8 is a schematic diagram showing a liquid ejection apparatus according to a third embodiment.

FIG. 9 is a schematic diagram showing the liquid ejection apparatus according to the third embodiment.

FIG. 10 is a schematic diagram showing the liquid ejection apparatus according to the third embodiment.

FIG. 11 is a schematic diagram showing the liquid ejection apparatus according to the third embodiment.

### DESCRIPTION OF EMBODIMENTS

### First Embodiment

An embodiment of a liquid ejection apparatus including a liquid container will hereinafter be described with reference to the drawings. In the following description, in a state where the liquid ejection apparatus is installed on a horizontal plane, an axis crossing the horizontal plane is defined as a Z axis, an axis crossing the Z axis is defined as an X axis, and an axis crossing the X axis and the Z axis is defined as a Y axis. One direction along the X axis is defined as a first width direction X1, and the other direction along the X axis is defined as a second width direction X2. One direction along the Y axis is defined as a frontward direction Y1, and the other direction along the Y axis is defined as a rearward direction Y2. An upward direction along the Z axis is defined as an upward direction Z1, and a downward direction along the Z axis is defined as a downward direction Z2. The first width direction X1 is an example of a first direction. The frontward direction Y1 is an example of a second direction. The upward direction Z1 is an example of a third direction. Viewing from the first width direction X1 is simply referred to as a side view. Viewing from the frontward direction Y1 side is simply referred to as a front view.

### Configuration of Liquid Ejection Apparatus 11

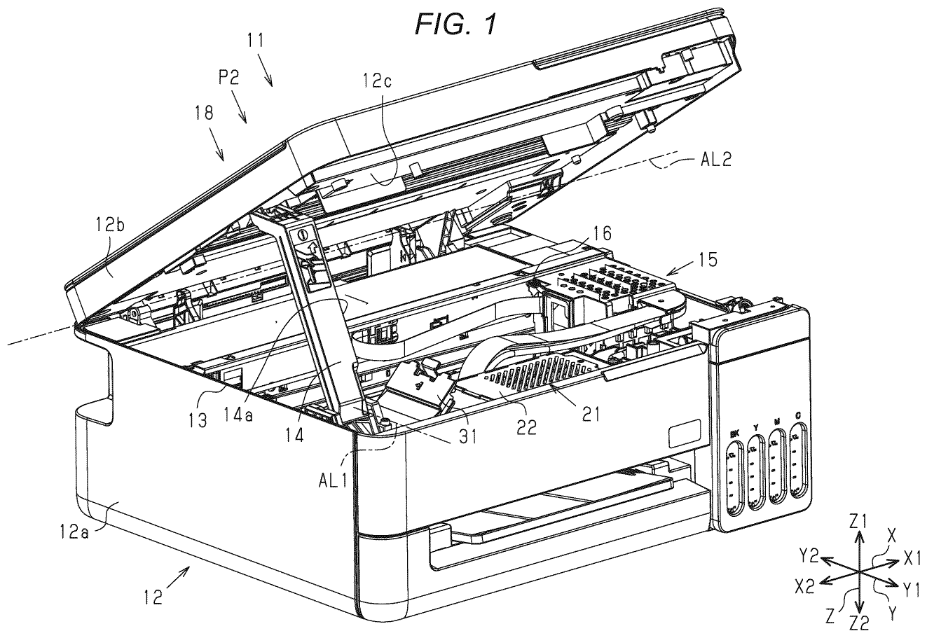

As shown in FIG. 1, a liquid ejection apparatus 11 is configured to eject a liquid onto a medium to thereby perform printing. The liquid ejection apparatus 11 may be an inkjet printer that performs printing by ejecting ink, which is an example of the liquid, onto the medium. The medium may be, for example, paper, fabric, vinyl, a plastic component, or a metal component.

The liquid ejection apparatus 11 includes a housing 12. The housing 12 is configured to house various members constituting the liquid ejection apparatus 11. The housing 12 is configured as an exterior of the liquid ejection apparatus 11.

The housing 12 includes a housing main body 12a and a housing cover 12b. That is, the liquid ejection apparatus 11 includes the housing main body 12a and the housing cover 12b. The housing main body 12a is configured to house various members constituting the liquid ejection apparatus 11. The housing main body 12a is provided with an opening portion 13. The user can access various members in the housing 12 through the opening portion 13.

The housing cover 12b is disposed at the upward direction Z1 side of the housing main body 12a. The housing cover 12b is an example of a second rotary section. The housing cover 12b rotates about a second axis AL2. The housing cover 12b can open and close the opening portion 13. The second axis AL2 extends along the first width direction X1.

The housing cover 12b is rotatably disposed between a first position P1 and a second position P2. The first position P1 is a position where an inside of the housing main body 12a is covered through the opening portion 13. The first position P1 may be a position where the housing cover 12b is along a horizontal plane.

The second position P2 is a position where the inside of the housing main body 12a is exposed through the opening portion 13. The second position P2 may be a position where the housing cover 12b faces to the upward direction Z1 with reference to the second axis AL2.

The liquid ejection apparatus 11 includes a holder 14. The holder 14 is configured to hold the housing cover 12b at the second position P2. The holder 14 includes a stopper (not illustrated) at the rearward direction Y2 side. The holder 14 holds the housing cover 12b from the downward direction Z2 side at the second position P2 by the stopper and the housing main body 12a coming into contact with each other.

The liquid ejection apparatus 11 includes a liquid ejection unit 15. The liquid ejection unit 15 is configured to eject the liquid onto the medium. The liquid ejection unit 15 includes a head (not illustrated). The head ejects the liquid onto the medium.

The head may be of a serial type or may be of a line type. The serial type head performs printing by ejecting a liquid onto a medium while moving. The line type head is disposed so as to be elongated along a width of a medium and performs printing by ejecting a liquid onto the medium.

The liquid ejection unit 15 may include a carriage 16. The carriage 16 is configured to support the head. The carriage 16 is configured to reciprocate along the X axis with driving force from a carriage driver (not illustrated).

The liquid ejection apparatus 11 may include an image reader 18. The image reader 18 is provided to the housing cover 12b. In particular, the image reader 18 is disposed at the upward direction Z1 side of the housing cover 12b. The image reader 18 may be configured integrally with the housing cover 12b. The image reader 18 reads an image from a document. The image reader 18 is of a flatbed type on which the document can be set, but may have an automatic document feed function.

The liquid ejection apparatus 11 includes a mounting portion 21. The mounting portion 21 is housed in the housing 12. That is, the housing 12 houses the mounting portion 21. The mounting portion 21 is housed in the housing main body 12a. That is, the housing main body 12a houses the mounting portion 21.

When the housing cover 12b is disposed at the second position P2, the mounting portion 21 is configured to be accessible through the opening portion 13. As described above, the opening portion 13 is configured so that the mounting portion 21 can be accessed in the housing main body 12a. The first position P1 is a position where the mounting portion 21 is covered. The second position P2 is a position where the mounting portion 21 is exposed.

The mounting portion 21 is configured so that the liquid container 22 can be mounted. The mounting portion 21 is configured such that the liquid container 22 can be detached in the upward direction Z1. The direction in which the liquid container 22 is detached from the mounting portion 21 is not required to be limited to the upward direction Z1 as long as a container cover 31 can fix the liquid container 22 to the mounting portion 21.

The liquid container 22 is configured to store the liquid. The liquid container 22 may be a waste liquid container. That is, the liquid ejection apparatus 11 may include the waste liquid container as the liquid container 22. The waste liquid container stores, as a waste liquid, the liquid discharged from the liquid ejection unit 15.

The liquid ejection apparatus 11 includes the container cover 31. The container cover 31 is an example of a first rotary section. The container cover 31 is housed in the housing 12. That is, the container cover 31 is housed in the housing main body 12a. The container cover 31 may be disposed at the second width direction X2 side of the mounting portion 21.

The container cover 31 is rotatable about a first axis AL1. The container cover 31 is rotatable about the first axis AL1 from a horizontal plane toward the upward direction Z1. The first axis AL1 extends along the frontward direction Y1. The first axis AL1 and the second axis AL2 are orthogonal to each other in a plane including the X axis and the Y axis.

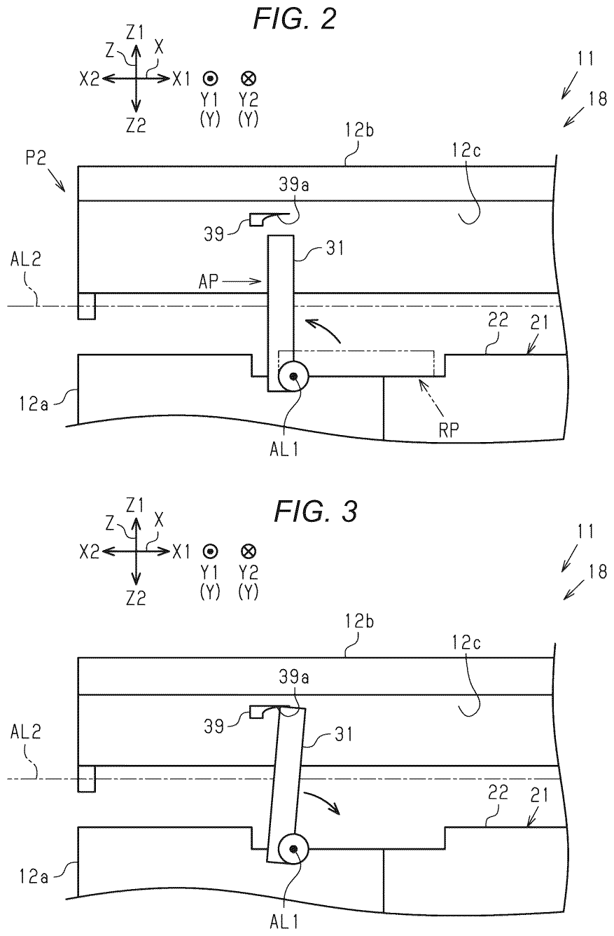

As shown in FIG. 2, the container cover 31 is disposed rotatably between a restriction position RP and a permission position AP. The restriction position RP is a position where the movement of the liquid container 22 mounted on the mounting portion 21 is restricted. When the container cover 31 is disposed at the restriction position RP, the container cover 31 restricts the movement in the upward direction Z1 of the liquid container 22 mounted on the mounting portion 21. The restriction position RP may be a position where the container cover 31 is along a plane including the X axis and the Y axis. When the housing cover 12b is rotationally operated from the second position P2 to the first position P1, the restriction position RP is a position where the container cover 31 is not disposed within the movement range of the housing cover 12b.

The permission position AP is a position where the movement of the liquid container 22 mounted on the mounting portion 21 is permitted. When the container cover 31 is disposed at the permission position AP, the container cover 31 permits the liquid container 22 mounted on the mounting portion 21 to move in the upward direction Z1. The permission position AP may be a position where the container cover 31 faces to the upward direction Z1 with reference to the first axis AL1. When the housing cover 12b is rotationally operated from the second position P2 to the first position P1, the permission position AP is a position where the container cover 31 is disposed within the movement range of the housing cover 12b.

The restriction position RP and the permission position AP have an angular difference of 90 degrees about the first axis AL1, but may have an angular difference smaller than 90 degrees. As described above, the restriction position RP and the permission position AP may have an angular difference no larger than 90 degrees about the first axis AL1.

### Configuration of Guide Portion 39

As illustrated in FIG. 2, the liquid ejection apparatus 11 includes a guide portion 39. The guide portion 39 is provided to the housing cover 12b. Specifically, the guide portion 39 is provided at the mounting portion 21 side in the housing cover 12b. That is, the guide portion 39 is provided to a bottom surface 12c. The guide portion 39 is provided to extend in a direction along the first width direction X1, but may be provided to extend in a direction along the frontward direction Y1. The guide portion 39 is disposed to protrude in the downward direction Z2 from the bottom surface 12c of the housing cover 12b.

The guide portion 39 makes a rotational movement together with the housing cover 12b due to the rotational operation of the housing cover 12b. The guide portion 39 is housed in the housing main body 12a when the housing cover 12b is disposed at the first position P1.

The guide portion 39 may include a contact surface 39a. The contact surface 39a is a surface that makes contact with the container cover 31. The contact surface 39a is a curved surface. That is, the guide portion 39 has a curved surface. Specifically, the contact surface 39a may be a curved surface having a circular-arc shape centered on an axis along the Y axis. The contact surface 39a may be a curved surface a point on which approaches the bottom surface 12c as proceeding toward the first width direction X1.

As illustrated in FIG. 3, when the container cover 31 is disposed at the permission position AP, when the rotational operation of the housing cover 12b is performed in a direction from the second position P2 toward the first position P1, the guide portion 39 comes into contact with the container cover 31. The guide portion 39 rotates the container cover 31 from the permission position AP toward the restriction position RP by coming into contact with the container cover 31 due to the rotational operation of the housing cover 12b from the second position P2 to the first position P1. The container cover 31 rotates from the permission position AP toward the restriction position RP due to the contact with the guide portion 39. In particular, the container cover 31 rotates clockwise from the permission position AP toward the restriction position RP due to the contact with the guide portion 39 in a front view.

Specifically, the contact surface 39a comes into contact with the container cover 31 due to the rotational operation of the housing cover 12b from the second position P2 to the first position P1. The contact surface 39a rotates the container cover 31 from the permission position AP toward the restriction position RP by coming into contact with the container cover 31.

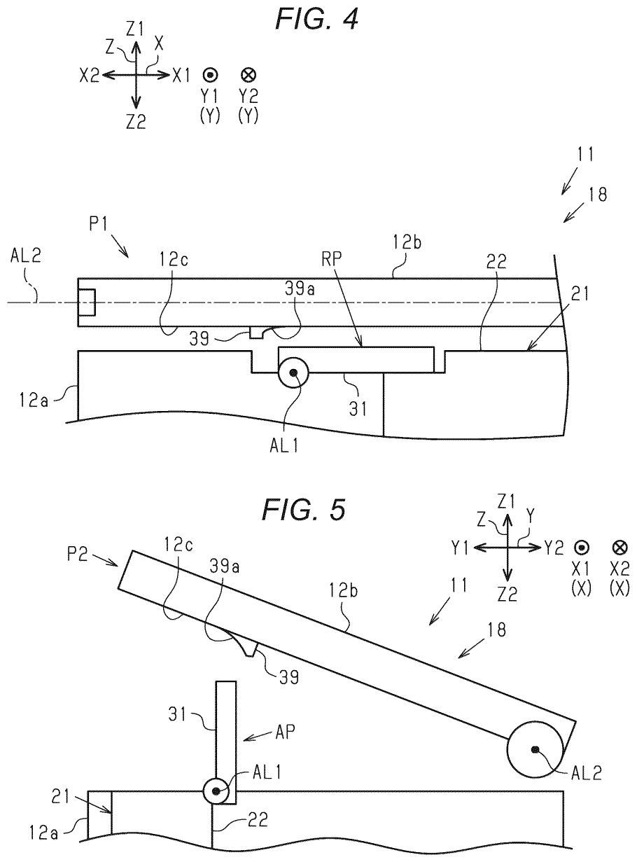

As illustrated in FIG. 4, the container cover 31 reaches the restriction position RP due to the contact with the guide portion 39. That is, the guide portion 39 rotates the container cover 31 from the permission position AP to the restriction position RP due to the rotational operation of the housing cover 12b from the second position P2 to the first position P1. The container cover 31 may rotate from the permission position AP toward the restriction position RP due to the contact with the guide portion 39 to reach the restriction position RP by its own weight.

Accordingly, after the container cover 31 is disposed at the restriction position RP, the housing cover 12b can make the rotational operation from the second position P2 to the first position P1 without pinching the container cover 31.

### Functions and Advantages of First Embodiment

The functions and advantages of the first embodiment will be described.

(1-1) The guide portion 39 rotates the container cover 31 from the permission position AP toward the restriction position RP due to the rotational operation of the housing cover 12b from the second position P2 to the first position P1. According to this configuration, when the container cover 31 is disposed at the permission position AP, even when the housing cover 12b is rotationally operated from the second position P2 to the first position P1, it is possible to prevent the container cover 31 from being pinched. Therefore, the convenience of the user can be improved.

(1-2) The guide portion 39 rotates the container cover 31 from the permission position AP to the restriction position RP due to the rotational operation of the housing cover 12b from the second position P2 to the first position P1. According to this configuration, when the container cover 31 is disposed at the permission position AP, when the container cover 12b is rotationally operated from the second position P2 to the first position P1, the container cover 31 can be rotated to the restriction position RP without rotating the container cover 31 itself. Therefore, the convenience of the user can be improved.

(1-3) The second axis AL2 extends along the first width direction X1, and the first axis AL1 extends along the frontward direction Y1 crossing the first width direction X1. According to this configuration, the guide portion 39 can rotate the container cover 31 from the permission position AP toward the restriction position RP due to the rotational operation of the housing cover 12b from the second position P2 to the first position P1. Therefore, the convenience of the user can be improved.

(1-4) The guide portion 39 is disposed at the mounting portion 21 side in the housing cover 12b, and includes a curved surface that rotates the container cover 31 from the permission position AP toward the restriction position RP by coming into contact with the container cover 31. According to this configuration, the guide portion 39 can smoothly rotate the container cover 31 from the permission position AP toward the restriction position RP along the curved surface. Therefore, the convenience of the user can be improved.

(1-5) The restriction position RP and the permission position AP have an angular difference no larger than 90 degrees about the first axis AL1. According to this configuration, the guide portion 39 can easily rotate the container cover 31 due to the rotational operation of the housing cover 12b from the second position P2 to the first position P1. Therefore, the convenience of the user can be improved.

(1-6) The container cover 31 restricts the movement of the liquid container 22 in the upward direction Z1 in which the liquid container 22 can be detached. According to this configuration, when the liquid container 22 is mounted on the mounting portion 21, it is possible to improve the reliability of restriction of the movement of the liquid container 22.

(1-7) The liquid container 22 is the waste liquid container that stores, as a waste liquid, the liquid discharged from the liquid ejection unit 15. According to this configuration, even when the container cover 31 is disposed at the permission position AP at the time of attaching and detaching the waste liquid container, the container cover 31 can be rotated from the permission position AP toward the restriction position RP due to the rotational operation of the housing cover 12b from the second position P2 to the first position P1. Therefore, the convenience of the user can be improved.

(1-8) The housing cover 12b covers the opening portion 13 at the first position P1. According to this configuration, the container cover 31 is disposed at the permission position AP when the liquid container 22 is attached and detached through the opening portion 13. Even in such a case, the guide portion 39 can rotate the container cover 31 from the permission position AP toward the restriction position RP due to the rotational operation of the housing cover 12b from the second position P2 to the first position P1. Therefore, the convenience of the user can be improved.

(1-9) The image reader 18 is provided to the housing cover 12b. According to this configuration, since the image reader 18 is provided, the weight of the housing cover 12b is larger than when the image reader 18 is not provided. Even in such a case, the guide portion 39 can rotate the container cover 31 from the permission position AP toward the restriction position RP by performing the rotational operation of the housing cover 12b from the second position P2 to the first position P1. Therefore, the convenience of the user can be improved.

### Second Embodiment

Then, a second embodiment will be described. In the following description, redundant descriptions of the same configurations as those of the embodiment having already been described will be omitted or simplified, and configurations different from those of the embodiment having already been described will be described.

### Configuration of Liquid Ejection Apparatus 11

As shown in FIG. 5, in the second embodiment, the first axis AL1 extends along the first width direction X1. That is, in the second embodiment, the first axis AL1 and the second axis AL2 extend along the first width direction X1. The container cover 31 may be disposed at the rearward direction Y2 side of the mounting portion 21. The housing cover 12b and the container cover 31 are the same in rotational direction.

The guide portion 39 is disposed so as to extend in a direction along the frontward direction Y1, but may be disposed so as to extend in a direction along the first width direction X1. The contact surface 39a may be a curved surface having a circular-arc shape centered on an axis along the X axis. The contact surface 39a may be a curved surface a point on which approaches the bottom surface 12c as proceeding toward the frontward direction Y1. In the second embodiment, the contact surface 39a may be a curved surface having a gentler inclination than in the first embodiment.

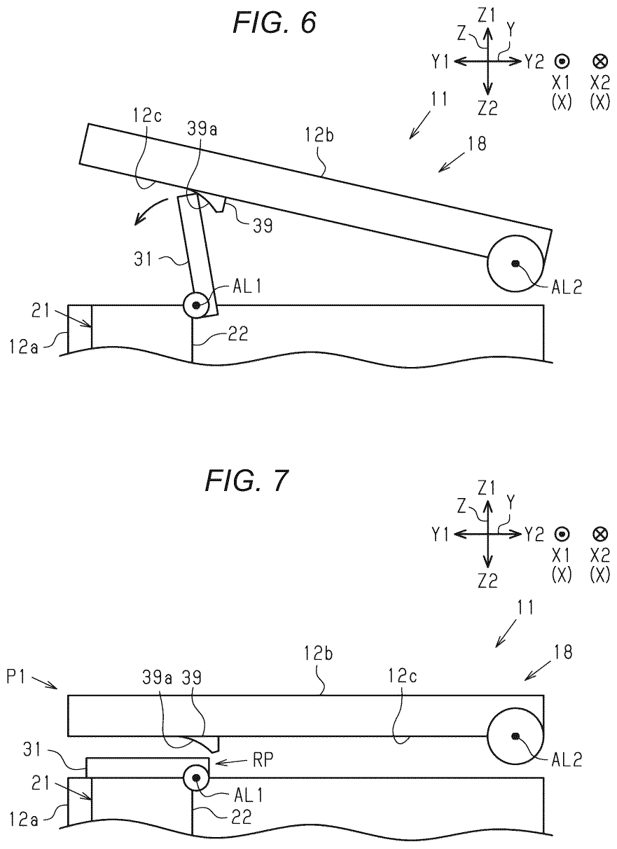

As illustrated in FIG. 6, the guide portion 39 rotates the container cover 31 from the permission position AP toward the restriction position RP by coming into contact with the container cover 31 due to the rotational operation of the housing cover 12b from the second position P2 to the first position P1. The container cover 31 rotates counterclockwise from the permission position AP toward the restriction position RP by having contact with the guide portion 39 in a side view.

As illustrated in FIG. 7, the container cover 31 reaches the restriction position RP by coming into contact with the guide portion 39. That is, the guide portion 39 rotates the container cover 31 from the permission position AP to the restriction position RP due to the rotational operation of the housing cover 12b from the second position P2 to the first position P1.

Accordingly, after the container cover 31 is disposed at the restriction position RP, the housing cover 12b can make the rotational operation from the second position P2 to the first position P1 without pinching the container cover 31.

### Functions and Advantages of Second Embodiment

The functions and advantages of the second embodiment will be described.

(2-1) The first axis AL1 and the second axis AL2 extend along the first width direction X1. According to this configuration, the rotational axes of the container cover 31 and the housing cover 12b extend along the same first width direction X1. Accordingly, the guide portion 39 can easily rotate the container cover 31 due to the rotational operation of the housing cover 12b from the second position P2 to the first position P1. Therefore, the convenience of the user can be improved.

(2-2) The container cover 31 and the housing cover 12b are the same in rotational direction. According to this configuration, the guide portion 39 easily transmits the power to the container cover 31 by making contact with the container cover 31 due to the rotational operation of the housing cover 12b from the second position P2 to the first position P1. Therefore, the guide portion 39 can easily rotate the container cover 31. Therefore, the convenience of the user can be improved.

### Third Embodiment

Then, a third embodiment will be described.

### Configuration of Liquid Ejection Apparatus 11

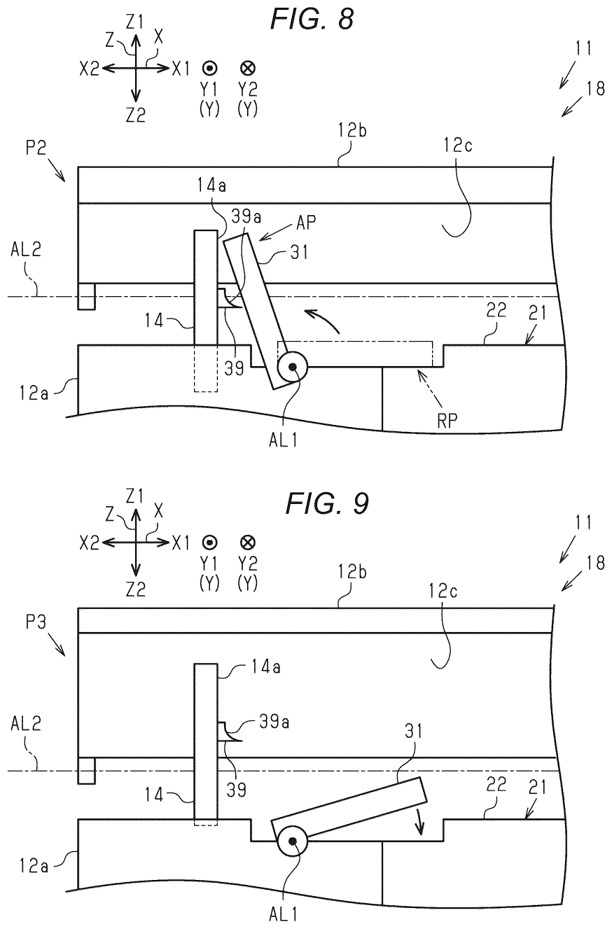

As shown in FIG. 8, in the third embodiment, unlike the first embodiment, the guide portion 39 is provided to the holder 14. Specifically, the guide portion 39 is disposed at the container cover 31 side of the holder 14. The guide portion 39 is disposed so as to protrude from a side surface 14a of the holder 14 in the first width direction X1.

When the housing cover 12b is at the second position P2, the guide portion 39 may, but is not required to, be in contact with the container cover 31 located at the permission position AP. The guide portion 39 may have any shape as long as the guide portion 39 can make contact with the container cover 31 to rotate the container cover 31. In particular, the contact surface 39a may have any shape as long as the contact surface 39a can make contact with the container cover 31 to rotate the container cover 31. For example, the contact surface 39a may be a curved surface a point on which approaches the side surface 14a of the holder 14 as proceeding toward the upward direction Z1. The contact surface 39a is not required to be a curved surface.

The permission position AP is a position at which the container cover 31 is inclined to the second width direction X2 side with respect to the Z axis about the first axis AL1. The restriction position RP and the allowable position AP have an angular difference of, for example, 110 degrees, but may have an angular difference larger than 90 degrees about the first axis AL1.

As illustrated in FIG. 9, the housing cover 12b is rotationally operated from the second position P2 to a third position P3. The third position P3 is a position at an opposite direction side to the first position P1 with reference to the second position P2. The third position P3 is a position where the mounting portion 21 is exposed.

In the third embodiment, when rotationally operating the housing cover 12b from the second position P2 to the first position P1, by rotationally operating the housing cover 12b once from the second position P2 to the third position P3, the contact between the stopper (not illustrated) of the holder 14 and the housing main body 12a is released. Subsequently, the housing cover 12b is rotationally operated from the third position P3 to the first position P1.

That is, the rotational operation of the housing cover 12b from the second position P2 to the first position P1 includes an operation of rotating the housing cover 12b from the second position P2 to the third position P3 and then rotating the housing cover 12b from the third position P3 to the first position P1.

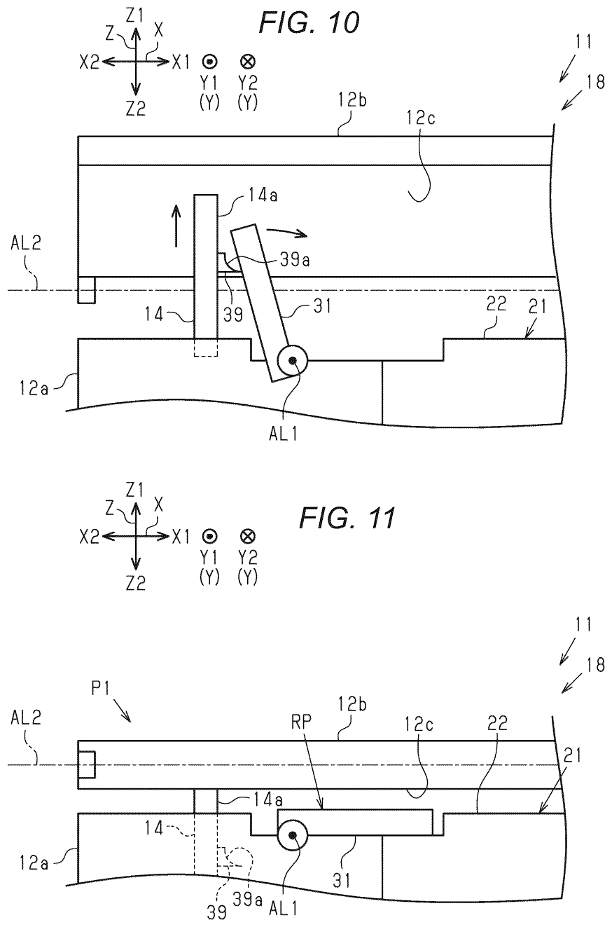

As illustrated in FIG. 10, the holder 14 moves in the upward direction Z1 with the rotational operation of the housing cover 12b from the second position P2 to the third position P3. Accordingly, the guide portion 39 moves to the upward direction Z1 with the rotational operation of the housing cover 12b from the second position P2 to the third position P3.

The guide portion 39 rotates the container cover 31 from the permission position AP toward the restriction position RP by coming into contact with the container cover 31 due to the rotational operation of the housing cover 12b from the second position P2 to the third position P3.

Specifically, the contact surface 39a comes into contact with the container cover 31 due to the rotational operation of the housing cover 12b from the second position P2 to the third position P3. The contact surface 39a rotates the container cover 31 from the permission position AP toward the restriction position RP by coming into contact with the container cover 31.

As illustrated in FIG. 11, the container cover 31 reaches the restriction position RP by coming into contact with the guide portion 39. The container cover 31 may rotate from the permission position AP toward the restriction position RP due to the contact with the guide portion 39 to reach the restriction position RP by its own weight.

Accordingly, after the container cover 31 is disposed at the restriction position RP, the housing cover 12b can make the rotational operation from the second position P2 to the first position P1 via the third position P3 without pinching the container cover 31.

### Functions and Advantages of Third Embodiment

The functions and advantages of the third embodiment will be described.

(3-1) The guide portion 39 is provided to the side surface 14a of the holder 14. According to this configuration, the guide portion 39 provided to the side surface 14a of the holder 14 can rotate the container cover 31 from the permission position AP toward the restriction position RP due to the rotational operation of the housing cover 12b from the second position P2 to the first position P1. Therefore, the convenience of the user can be improved.

(3-2) The guide portion 39 rotates the container cover 31 from the permission position AP toward the restriction position RP due to the rotational operation of the housing cover 12b from the second position P2 to the third position P3. According to this configuration, when rotationally operating the housing cover 12b from the second position P2 to the first position P1, the housing cover 12b is rotationally operated from the second position P2 to the third position P3. Even in such a case, the guide portion 39 can rotate the container cover 31 from the permission position AP toward the restriction position RP. Therefore, the convenience of the user can be improved.

(3-3) The restriction position RP and the permission position AP have an angular difference larger than 90 degrees about the first axis AL1. According to this configuration, even when the angle difference between the restriction position RP and the permission position AP is greater than 90 degrees, the container cover 31 can be rotated from the permission position AP toward the restriction position RP due to the rotational operation of the housing cover 12b from the second position P2 to the third position P3. Therefore, the convenience of the user can be improved.

### Modified Examples

The present embodiment can be implemented with the modifications described below. The present embodiment and the following modified examples can be implemented in combination with each other as long as no technical inconsistencies are involved.

In the first embodiment and the second embodiment, the housing cover 12b may be rotationally operated from the second position P2 to the third position P3, and then rotationally operated from the third position P3 to the first position P1. In the first embodiment and the second embodiment, the liquid ejection apparatus 11 is not required to include the holder 14. In particular, the liquid ejection apparatus 11 is not required to include the holder 14 as long as a configuration capable of fixing the housing cover 12b at the second position P2 is separately provided.

In the first embodiment and the second embodiment, as long as the container cover 12b does not pinch the container cover 31 at the first position P1, the container cover 31 may be configured to be rotatable from the permission position AP in an opposite direction to the direction toward the restriction position RP.

The holder 14 may include the stopper (not illustrated) at the frontward direction Y1 side. The holder 14 may include the stopper (not illustrated) at the first width direction X1 side. The holder 14 may include the stopper (not illustrated) at the second width direction X2 side.

The housing cover 12b may rotate from the second position P2 toward the first position P1 to reach the first position P1 by its own weight when the stopper of the holder 14 and the housing main body 12a are not in contact with each other.

The housing cover 12b may include a mechanism capable of fixing the housing cover 12b at the restriction position RP. For example, as illustrated in FIG. 1, the housing cover 12b may include a stopper. The user can release the housing cover 12b fixed to the restriction position RP by tilting the stopper toward the second width direction X2.

The housing cover 12b located at the first position P1 and the container cover 31 located at the restriction position RP may overlap each other in a top view. The housing cover 12b located at the first position P1 and the container cover 31 located at the restriction position RP are in a parallel state in a front view. The housing cover 12b located at the first position P1 may overlap the second axis AL2 in a front view.

The liquid container 22 may store a liquid other than the waste liquid. The liquid container 22 may contain the liquid to be supplied to the liquid ejection unit 15. The liquid container 22 may contain the liquid discharged from others than the liquid ejection unit 15.

In the first embodiment, the container cover 31 may be disposed at the first width direction X1 side of the mounting portion 21. In particular, the container cover 31 may rotate counterclockwise from the permission position AP toward the restriction position RP in a front view. On this occasion, the contact surface 39a may be a curved surface a point on which approaches the bottom surface 12c as proceeding in the second width direction X2.

In the second embodiment, the container cover 31 may be disposed at the frontward direction Y1 side of the mounting portion 21. In particular, the container cover 31 may rotate clockwise from the permission position AP toward the restriction position RP in a side view. On this occasion, the contact surface 39a may be a curved surface a point on which approaches the bottom surface 12c as proceeding in the rearward direction Y2.

In the third embodiment, the container cover 31 may be disposed at the first width direction X1 side of the mounting portion 21. In this case, the holder 14 may be disposed at the first width direction X1 side of the container cover 31. The guide portion 39 may be provided to a side surface at the second width direction X2 side of the holder 14. The container cover 31 may rotate counterclockwise from the permission position AP toward the restriction position RP by making contact with the guide portion 39 disposed at the first width direction X1 side of the mounting portion 21 in a front view. On this occasion, the contact surface 39a may be a curved surface a point on which approaches the bottom surface 12c as proceeding in the second width direction X2.

In the second embodiment, the direction in which the container cover 12b is rotationally operated from the second position P2 to the first position P1 may be different from the direction in which the container cover 31 rotates from the permission position AP to the restriction position RP. The guide portion 39 may be disposed so as to extend longer when the housing cover 12b and the container cover 31 rotate in respective directions different from each other than when the housing cover 12b and the container cover 31 rotate in the same direction. In particular, the contact surface 39a may be disposed so as to extend longer when the housing cover 12b and the container cover 31 rotate in respective directions different from each other than when the housing cover 12b and the container cover 31 rotate in the same direction.

The liquid ejection apparatus 11 may include two or more holders 14. For example, the liquid ejection apparatus 11 may include the holders 14 respectively at the first width direction X1 side of the mounting portion 21 and at the second width direction X2 side of the mounting portion 21.

The housing cover 12b and the container cover 31 may be the same in rotation direction or may be different in rotation direction. In particular, the rotation directions of the housing cover 12b and the container cover 31 may be opposite to each other or may cross each other.

The second axis AL2 may be disposed at a position in a direction along the first width direction X1. The second axis AL2 may be located at the second width direction X2 side in the housing main body 12a. In this case, the housing cover 12b may be disposed to be rotatable counterclockwise in a front view. The second axis AL2 may be located at the first width direction X1 side in the housing main body 12a. In this case, the housing cover 12b is disposed to be rotatable clockwise in a front view.

The guide portion 39 may be in contact with the container cover 31 until the container cover 31 is rotated to the restriction position RP. The housing cover 12b may include a pressing member at the bottom surface 12c separately from the guide portion 39. The pressing member rotates the container cover 31 to the restriction position RP by pressing the container cover 31.

The container cover 31 may be provided with a protruding portion having a convex shape at a side in contact with the contact surface 39a. For example, the container cover 31 may rotate from the permission position AP toward the restriction position RP by the guide portion 39 being caught by the protruding portion, and reach the restriction position RP.

The contact surface 39a may be a straight line instead of the curved surface as long as the contact surface 39a can rotate the container cover 31 from the permission position AP to the restriction position RP by making contact with the container cover 31. That is, the guide portion 39 is not required to include the curved surface.

The expression “at least any of” used in the present specification means one or more of desired options. As an example, when the number of options is two, the expression “at least any of” used in the present specification means one of the options only or both of the two options. As another example, when the number of options is three or more, the expression “at least any of” used in the present specification means one of the options only or a combination of any two or more of the options.

### Appendices

Technical ideas figured out from the embodiments and the modified examples described above and the functions and advantages thereof will hereinafter be described. The technical ideas, and the functions and advantages thereof can be combined with each other within a range where no technical contradictions are involved.

[1] A liquid ejection apparatus includes a first rotary section configured to rotate about a first axis between a restriction position where movement of a liquid container mounted on a mounting portion is restricted and a permission position where the movement of the liquid container mounted on the mounting portion is permitted, a second rotary section configured to rotate about a second axis at a position where the second rotary section passes through a first position where the mounting portion is covered and a second position where the mounting portion is exposed, and a guide portion configured to rotate the first rotary section by coming into contact with the first rotary section, wherein the guide portion rotates the first rotary section from the permission position toward the restriction position due to a rotational operation of the second rotary section from the second position to the first position.

According to this configuration, the guide portion can rotate the first rotary section from the permission position toward the restriction position due to the rotational operation of the second rotary section from the second position to the first position. Accordingly, when the first rotary section is disposed at the permission position, the second rotary section can be prevented from pinching the first rotary section even when the second rotary section is rotated from the second position to the first position. Therefore, the convenience of the user can be improved.

[2] In the liquid ejection apparatus described above, the guide portion rotates the first rotary section from the permission position to the restriction position due to the rotational operation of the second rotary section from the second position to the first position.

According to this configuration, the guide portion can rotate the first rotary section from the permission position to the restriction position due to the rotational operation of the second rotary section from the second position to the first position. Accordingly, when the first rotary section is disposed at the permission position, when the second rotary section is rotationally operated from the second position to the first position, it is possible to rotate the first rotary section to the restriction position without performing the rotational operation of the first rotary section itself. Therefore, the convenience of the user can be improved.

[3] In the liquid ejection apparatus described above, the first axis and the second axis extend along a first direction. According to this configuration, the rotation axes of the first rotary section and the second rotary section extend along the same first direction. Accordingly, the guide portion can easily rotate the first rotary section due to the rotational operation of the second rotary section from the second position to the first position. Therefore, the convenience of the user can be improved.

[4] In the liquid ejection apparatus described above, the first rotary section and the second rotary section are same in rotation direction. According to this configuration, the guide portion easily transmits the power to the first rotary section by coming into contact with the first rotary section due to the rotational operation of the second rotary section from the second position to the first position. Therefore, the guide portion can easily rotate the first rotary section. Therefore, the convenience of the user can be improved.

[5] In the liquid ejection apparatus described above, the second axis extends along a first direction, and the first axis extends along a second direction crossing the first direction. According to this configuration, the first rotary section and the second rotary section cross each other. Even in this case, the guide portion can rotate the first rotary section from the permission position toward the restriction position due to the rotational operation of the second rotary section from the second position to the first position. Therefore, the convenience of the user can be improved.

[6] In the liquid ejection apparatus described above, the guide portion is disposed at the mounting portion side in the second rotary section, and includes a curved surface configured to rotate the first rotary section from the permission position toward the restriction position by making contact with the first rotary section.

According to this configuration, the guide portion can smoothly rotate the first rotary section from the permission position toward the restriction position along the curved surface. Therefore, the convenience of the user can be improved.

[7] In the liquid ejection apparatus described above, the restriction position and the permission position have an angular difference no larger than 90 degrees about the first axis. According to this configuration, the guide portion can easily rotate the first rotary section due to the rotational operation of the second rotary section from the second position to the first position. Therefore, the convenience of the user can be improved.

[8] In the liquid ejection apparatus described above, there is further provided a holder configured to hold the second rotary section at the second position, wherein the guide portion is provided to the holder. According to this configuration, the guide portion provided to the holder can rotate the first rotary section from the permission position toward the restriction position due to the rotational operation of the second rotary section from the second position to the first position. Therefore, the convenience of the user can be improved.

[9] In the liquid ejection apparatus described above, the second rotary section is configured to rotate from the second position to a third position located at an opposite direction side to the first position, the third position is a position at which the mounting portion is exposed, the rotational operation of the second rotary section from the second position to the first position includes an operation of rotating the second rotary section from the second position to the third position and then rotating the second rotary section from the third position to the first position, and the guide portion rotates the first rotary section from the permission position toward the restriction position due to the rotational operation of the second rotary section from the second position to the third position.

According to this configuration, even when performing the rotational operation of the second rotary section from the second position to the third position at the opposite direction side to the first position when rotationally operating the second rotary section from the second position to the first position, the guide portion can rotate the first rotary section from the permission position toward the restriction position. Therefore, the convenience of the user can be improved.

[10] In the liquid ejection apparatus described above, the restriction position and the permission position have an angular difference larger than 90 degrees about the first axis. According to this configuration, even when the angle difference between the restriction position and the permission position is larger than 90 degrees, the guide portion can rotate the first rotary section from the permission position toward the restriction position due to the rotational operation of the second rotary section from the second position to the first position. Therefore, the convenience of the user can be improved.

[11] In the liquid ejection apparatus described above, the first rotary section restricts movement of the liquid container in a third direction in which the liquid container can be detached. According to this configuration, when the liquid container is mounted on the mounting portion, it is possible to improve the reliability of restriction of the movement of the liquid container.

[12] In the liquid ejection apparatus described above, the liquid container is a waste liquid container configured to store, as a waste liquid, a liquid discharged from a liquid ejection unit. According to this configuration, even when the first rotary section is disposed at the permission position when attaching and detaching the waste liquid container, the guide portion can rotate the first rotary section from the permission position toward the restriction position due to the rotational operation of the second rotary section from the second position to the first position. Therefore, the convenience of the user can be improved.

[13] In the liquid ejection apparatus described above, there is further provided a housing main body configured to house the mounting portion, wherein the housing main body is provided with an opening portion through which the mounting portion is accessed, and the second rotary section covers the opening portion at the first position.

According to this configuration, even when the first rotary section is disposed at the permission position when the liquid container is attached and detached through the opening portion, the guide portion can rotate the first rotary section from the permission position toward the restriction position due to the rotational operation of the second rotary section from the second position to the first position. Therefore, the convenience of the user can be improved.

[14] In the liquid ejection apparatus described above, there is further provided an image reader configured to read an image from a document, wherein the image reader is provided to the second rotary section. According to this configuration, the second rotary section is provided with the image reader, and is therefore heavier in weight than when the image reader is not provided. Even in such a case, by rotationally operating the second rotary section from the second position to the first position, the guide portion can rotate the first rotary section from the permission position toward the restriction position. Therefore, the convenience of the user can be improved.

What is claimed is:

1. A liquid ejection apparatus comprising:
a liquid ejection unit configured to eject a liquid;
a mounting portion on which a liquid container configured to store the liquid is mounted;
a first rotary section configured to rotate about a first axis between a restriction position where movement of the liquid container mounted on the mounting portion is restricted and a permission position where the movement of the liquid container mounted on the mounting portion is permitted;
a second rotary section configured to rotate about a second axis at a position where the second rotary section passes through a first position where the mounting portion is covered and a second position where the mounting portion is exposed; and
a guide portion configured to rotate the first rotary section by coming into contact with the first rotary section, wherein
the guide portion rotates the first rotary section from the permission position toward the restriction position due to a rotational operation of the second rotary section from the second position to the first position.

2. The liquid ejection apparatus according to claim 1, wherein
the guide portion rotates the first rotary section from the permission position to the restriction position due to the rotational operation of the second rotary section from the second position to the first position.

3. The liquid ejection apparatus according to claim 1, wherein
the first axis and the second axis extend along a first direction.

4. The liquid ejection apparatus according to claim 3, wherein
the first rotary section and the second rotary section are same in rotation direction.

5. The liquid ejection apparatus according to claim 1, wherein
the second axis extends along a first direction, and
the first axis extends along a second direction crossing the first direction.

6. The liquid ejection apparatus according to claim 1, wherein
the guide portion is disposed at a side of the mounting portion in the second rotary section, and includes a curved surface configured to rotate the first rotary section from the permission position toward the restriction position by making contact with the first rotary section.

7. The liquid ejection apparatus according to claim 6, wherein
the restriction position and the permission position have an angular difference no larger than 90 degrees about the first axis.

8. The liquid ejection apparatus according to claim 1, further comprising
a holder configured to hold the second rotary section at the second position, wherein
the guide portion is provided to the holder.

9. The liquid ejection apparatus according to claim 8, wherein
the second rotary section is configured to rotate from the second position to a third position located at an opposite direction side to the first position,
the third position is a position at which the mounting portion is exposed,
the rotational operation of the second rotary section from the second position to the first position includes an operation of rotating the second rotary section from the second position to the third position and then rotating the second rotary section from the third position to the first position, and
the guide portion rotates the first rotary section from the permission position toward the restriction position due to the rotational operation of the second rotary section from the second position to the third position.

10. The liquid ejection apparatus according to claim 9, wherein
the restriction position and the permission position have an angular difference larger than 90 degrees about the first axis.

11. The liquid ejection apparatus according to claim 1, wherein
the first rotary section restricts movement of the liquid container in a third direction in which the liquid container is detached.

12. The liquid ejection apparatus according to claim 1, wherein
the liquid container is a waste liquid container configured to store, as a waste liquid, a liquid discharged from the liquid ejection unit.

13. The liquid ejection apparatus according to claim 1, further comprising
a housing main body configured to house the mounting portion, wherein
the housing main body is provided with an opening portion through which the mounting portion is accessed, and
the second rotary section covers the opening portion at the first position.

14. The liquid ejection apparatus according to claim 1, further comprising
an image reader configured to read an image from a document, wherein
the image reader is provided to the second rotary section.
